(19) United States
(12) Patent Application Publication
(10) Pub. No.: US 2004/0078217 A1
(43) Pub. Date: Apr. 22, 2004

(54) System and method for managing prepartum medical records

(76) Inventors: Anthony E. Bacevice, Avon Lake, OH (US); Edward J. Klimas, Lyndhurst, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/162,319

(22) Filed: Jun. 4, 2002

(51) Int. Cl. G06F 17/60

(52) U.S. Cl. 705/2

(57) ABSTRACT

A method for managing prepartum medical records is provided. The method provides a computer executable methodology for receiving an electronically configurable prepartum medical record viewer and then managing prepartum medical records through the received viewer.

### TECHNICAL FIELD

The methods, systems, application programming interfaces (API), graphical user interfaces (GUI), signals and computer readable media described herein relate generally to computer programming and more particularly to managing prepartum medical records.

### BACKGROUND OF THE INVENTION

Doctors typically dictate and/or hand write data that is collected into patient medical records that are then manually transcribed and filed. With the emergence of computers and other office equipment, medical record keeping has advanced well beyond the manual filing system For example, U.S. Pat. No. 6,347,329 B1, filed Aug. 1, 2000 and issued Feb. 12, 2002, concerns an electronic medical record system. The '329 patent teaches creating, and maintaining patient data electronically. Furthermore, the '329 patent teaches using a pen based portable computer with wireless connections to a computer network to facilitate accessing, analyzing, updating, and electronically annotating patient data. Similarly, U.S. Pat. No. 6,182,047 B1, filed Jun. 2, 1995 and issued Jan. 30, 2001, concerns a computerized medical information log system. The log system accepts data gathered during the patient visit and stores it in an organized database to facilitate subsequent retrieval. Advances in medical record keeping systems are not limited to software and databases. For example, U.S. Pat. No. 5,867,821 concerns distributing and administering medical records in a system that includes personal digital assistants (PDAs).

Perhaps recognizing the market potential for improved medical record keeping systems, industry has produced a variety of electronic record keeping systems. For example, calendar based reminder systems, patient demographic systems, hospital patient tracking systems, handheld database access systems, internet based clinical management systems, medical device linking systems, laboratory test tracking systems, and clinical workflow management systems have been developed, tested, and marketed. While these patented and/or marketed methods and systems may have improved medical record keeping, further improvements are still desired.

### SUMMARY OF THE INVENTION

The following presents a simplified summary of methods, systems, APIs, GUIs, signals, and computer readable media for managing prepartum medical records to facilitate providing a basic understanding of these items. This summary is not an extensive overview and is not intended to identify key or critical elements of the items described herein or to delineate the scope of these items. This summary provides a conceptual introduction in a simplified form as a prelude to the more detailed description that is presented later.

This application concerns a computer implemented method for managing prepartum medical records. The method includes electronically receiving into a handheld display device (e.g., personal digital assistant (PDA)), via a computer communication (e.g., binary large object (BLOB) transfer), an electronically customizable prepartum medical record viewer. The electronically customizable prepartum medical record viewer facilitates performing actions including, but not limited to, reading, writing, updating, deleting, and synchronizing prepartum medical records, each of which can be considered a prepartum medical record management function.

The application also concerns a computer implemented method for managing prepartum medical records that includes receiving prepartum medical record data points. The prepartum medical record data points can be locally validated on, for example, a PDA. An application running on the PDA can then transmit, by a computer communication, a prepartum medical record management request that carries with it a validated prepartum medical record data point. In response to this request, the application and/or PDA can receive an updated prepartum medical record and/or an error code concerning the requested medical record management function. The methods described herein facilitate real time synchronization of a local prepartum medical record stored on a handheld device with a remotely stored prepartum medical record.

The application also concerns a system for managing prepartum medical records. The system includes an object hierarchy that facilitates modeling a prepartum medical record. Modeling the prepartum medical record in an object hierarchy simplifies abstracting prepartum records which in turn facilitates manipulating records by object oriented programs. The object hierarchy can also model components of the client server application that manage prepartum medical records. The system also includes a data store that stores computer executable components of a dynamically configurable client side prepartum medical record manager that can be transmitted from the first data store to a client application by a server application. The client application can then receive and assemble the components into a dynamically configurable client side prepartum medical record manager. The server application, written in an object oriented programming language (e.g., Smalltalk) can select and transmit components of the dynamically configurable client side prepartum medical record manager from the first data store to the client application. Once the dynamically configurable client side prepartum medical record manager has been transmitted, and assembled, prepartum medical records from a second data store can be selectively managed by the server application, the client application, and/or the dynamically configurable client side prepartum medical record manager. It is to be appreciated that the client application and/or the dynamically configurable prepartum medical record manager can be run on a handheld computing device like a PDA. It is to be further appreciated that the server application can transmit the components of the dynamically configurable client side prepartum medical record manager to the handheld computing device as a computer file (e.g., .PRC file) Alternatively, and/or additionally, the record manager can be transmitted as a BLOB in a computer communication.

The application also concerns a graphical user interface for the handheld, client side, prepartum medical record managing computer system. The graphical user interface simplifies receiving prepartum medical data points.

The application also concerns a set of application programming interfaces that facilitate programmers and/or processes interacting with a prepartum medical record application.

Certain illustrative examples are described herein in connection with the following description and the annexed drawings. These examples are indicative, however, of but a few of the various ways in which the principles of the methods, systems, APIs, GUIs, signals and computer readable media may be employed and thus are intended to be inclusive of equivalents. Other advantages and novel features may become apparent from the following detailed description when considered in conjunction with the drawings.

### BRIEF DESCRIPTION OF THE DRAWINGS

FIG. 1 is a schematic block diagram of an example system for managing prepartum medical records.

FIG. 2 is a schematic block diagram of an example system for managing prepartum medical records.

FIG. 3 illustrates an example data flow between components of a system for managing prepartum medical records.

FIG. 4 illustrates an example object hierarchy associated with managing prepartum medical records.

FIG. 5 illustrates an example data packet employed in a client server application for managing prepartum medical records.

FIG. 6 is a simulated screen shot from an electronically dynamically configurable prepartum medical record viewer.

FIG. 7 is a simulated screen shot from an electronically dynamically configurable prepartum medical record viewer.

FIG. 8 is a simulated screen shot from an electronically dynamically configurable prepartum medical record viewer.

FIG. 9 is a simulated screen shot from an electronically dynamically configurable prepartum medical record viewer.

FIG. 10 is a simulated screen shot from an electronically dynamically configurable prepartum medical record viewer.

FIG. 11 is a simulated screen shot from an electronically dynamically configurable prepartum medical record viewer.

FIG. 12 is a simulated screen shot from an electronically dynamically configurable prepartum medical record viewer.

FIG. 13 is a flow chart of an example method for managing prepartum medical records.

FIG. 14 is a flow chart of an example method for managing prepartum medical records.

FIG. 15 illustrates an example API employed in managing prepartum medical records.

FIG. 16 illustrates an example signal passing between a client application and a server application in an example prepartum medical record managing system.

FIG. 17 is a simulated screen shot from an electronically dynamically configurable prepartum medical record viewer.

FIG. 18 is a simulated screen shot from an electronically dynamically configurable prepartum medical record viewer.

### DETAILED DESCRIPTION

Example methods, systems, APIs, GUIs, signals, and computer readable media are now described with reference to the drawings, where like reference numerals are used to refer to like elements throughout. In the following description, for purposes of explanation, numerous specific details are set forth in order to facilitate thoroughly understanding the items described herein. It may be evident, however, that the items described herein can be practiced without these specific details. In other instances, well-known structures and devices are shown in block diagram form in order to simplify description.

As used in this application, the term “computer component” refers to a computer-related entity, either hardware, firmware, software, a combination thereof, or software in execution. For example, a computer component can be, but is not limited to being, a process running on a processor, a processor, an object, an executable, a thread of execution, a program and a computer. By way of illustration, both an application running on a server and the server can be computer components. One or more computer components can reside within a process and/or thread of execution and a computer component can be localized on one computer and/or distributed between two or more computers.

“Signal”, as used herein, includes but is not limited to one or more electrical or optical signals analog or digital, one or more computer instructions, a bit or bit stream, or the like.

“Software”, as used herein, includes but is not limited to, one or more computer readable and/or executable instructions that cause a computer or other electronic device to perform functions, actions and/or behave in a desired manner. The instructions may be embodied in various forms like routines, algorithms, modules, methods, threads, and/or programs. Software may also be implemented in a variety of executable and/or loadable forms including, but not limited to, a stand-alone program, a function call (local and/or remote), a servelet, an applet, instructions stored in a memory, part of an operating system or browser, and the like. It is to be appreciated that the computer readable and/or executable instructions can be located in one computer component and/or distributed between two or more communicating, co-operating, and/or parallel processing computer components and thus can be loaded and/or executed in serial, parallel, massively parallel and other manners.

“Computer communication,” as used herein, refers to a communication between two or more computers and can be, for example, a network transfer, a file transfer, an applet transfer, an e-mail, a hypertext transfer protocol (HTTP) message, a datagram, an object transfer, a binary large object (BLOB), and so on. A computer communication can occur across for example, a wireless system (e.g., IEEE 802.11), an ethernet system (e.g., IEEE 802.3) a token ring system (e.g., IEEE 802.5), a local area network (LAN), a wide area network (WAN), a point-to-point system, a circuit switching system, a packet switching system, and so on.

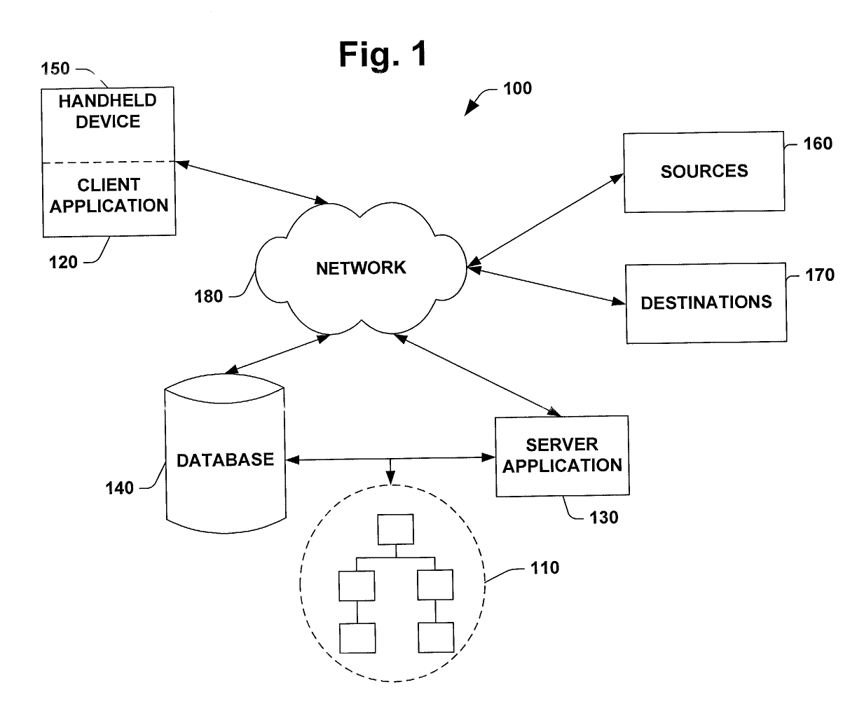

Referring initially to FIG. 1, an example system 100 for managing prepartum medical records is illustrated. Prepartum medical records are those medical records that contain information concerning a pregnant woman and/or her pregnancy. The system 100 includes an object hierarchy 110 that models a prepartum medical record. For example, a prepartum medical record may include information like the name of a patient, the number of times the patient has been pregnant, the result of those pregnancies, medications prescribed to the patient, genetic data, and so on. Additionally, and/or alternatively, the object hierarchy 110 can model other medical information (e.g., high risk cardiac care, nephrology, pediatric data). By modeling a prepartum medical record in an object oriented manner and storing the results of the modeling in an object hierarchy, the benefits of object oriented analysis and design can be brought to bear on the prepartum medical record environment. The benefits of object oriented analysis and design include reusability, portability, data hiding, encapsulation, interfaced based messaging, inheritance, polymorphism, ease of maintenance, reduced code bulk, reduced maintenance costs and so on. These benefits are well known in the art and thus are not discussed further for the sake of brevity.

The example system 100 also includes a client application 120. The client application 120 receives computer executable components of an electronically dynamically configurable client side prepartum medical record manager. Upon receiving these computer executable components, the client application 120 assembles the components into the record manager, making it available to manage prepartum medical records. In one example, the client application 120 receives components of the electronically dynamically configurable client side prepartum medical record manager in a computer communication as a BLOB. In another example, a client application corresponding to a database schema update is automatically generated and received as a single .PRC file ready for immediate execution on a handheld device 150 (e.g., PDA).

The object hierarchy 110 can also model components of a client/server application that manages prepartum medical records. The components can be transmitted to the client application 120 by, for example, a server application 130. The server application 130 is written in an object oriented programming language to facilitate taking advantage of the object hierarchy 110. Writing the server application 130 in an object oriented programming language also facilitates bringing to bear the advantages of object oriented analysis and design. The server application 130 selects and transmits components of the electronically dynamically configurable client side prepartum medical record manager to the client application 120 across, for example, a network 180. The network 180 can be, for example, a local area network (LAN), a wide area network (WAN), and the Internet. In one example, the server application 130 is written in the Smalltalk programming language. While Smalltalk is one example object-oriented language, it is to be appreciated that the server application 130 can be coded with other object oriented languages and/or network services (e.g., C++, Java, WebServices, .NET). Furthermore, the server application 130 may be written in a non object-oriented language (e.g., C). The server application 130 facilitates managing, for example, a database 140 that may store prepartum medical records and/or components of the electronically dynamically configurable client side prepartum medical record manager. The server application 130 also facilitates synchronizing data between the client application 120 and one or more data stores in the database 140. Furthermore, the server application 130 facilitates encrypting data for secure transmission and interchange.

The database 140 may hold, for example, a first data store that stores computer executable components of the electronically dynamically configurable client side prepartum medical record manager. These components may be stored, for example, as one or more BLOBs. The server application 130 then selects these BLOBs and selectively transmits them across the network 180 to the client application 120 in a computer communication. In another example, a PDA executable file (e.g., .PRC) corresponding to a database 140 update can be transmitted. In one example, the computer communication is a hypertext transfer protocol (HTTP) message. In another example, WebServices or other high level messaging protocols are employed in transmitting the executable file. The data store may be, for example, a relational database (e.g., DB2, Oracle, SQL Server). The database 140 may also hold a second data store that stores prepartum medical records. These records can be selectively managed by the server application 130, the client application 120, and/or the electronically dynamically configurable client side prepartum medical record manager. Managing these prepartum medical records can include, but is not limited to, reading a record, writing a record, updating a record, deleting a record, rejecting a record when a timestamp indicates it would overwrite more current data, and synchronizing a record at the client application 120 with a remote record stored in the database 140.

The system 100 may also include a handheld device 150 on which the client application 120 and/or the electronically dynamically configurable prepartum medical record manager runs. In one example, the handheld device 150 can be a handheld computing device like a Palm Pilot, a computer running Windows CE, a pocket PC, a cellular telephone, and other such similar devices. In another example, the handheld device 150 could be a laptop computer.

While the system 100 facilitates managing prepartum medical records on the handheld device 150, it is to be appreciated that the, prepartum medical records may be received from one or more sources 160 and displayed at one or more destinations 170. The sources include, but are not limited to, a doctor's office, a doctor's home, a hospital, a laboratory, an insurance company, and so on. Similarly, the destinations include, but are not limited to, the doctor's office, the hospital, and so on. The sources 160 and the destinations 170 communicate with components of the system 100 through the network 180.

The second data store stores the prepartum medical records. It is to be appreciated that the second data store may be a relational database (e.g., DB2). While a first and a second data store are discussed, it is to be appreciated that both the first and the second data store may be located in a single database like database 140. It is to be further appreciated that the data stores and/or the database 140 may be located on a single physical device and/or distributed between two or more physical devices and/or locations. Similarly, the database 140 can be located on one logical device and/or distributed between two or more communicating, cooperating distributed devices. It is to be appreciated that the communication can be continuous and/or intermittent. While the systems 100 and 200 are described primarily in connection with prepartum medical records, it is to be appreciated that the systems, methods, computer readable media and so on described herein can be employed to manage other dynamic record types (e.g., cardiac, pediatric, technical, legal, etc.).

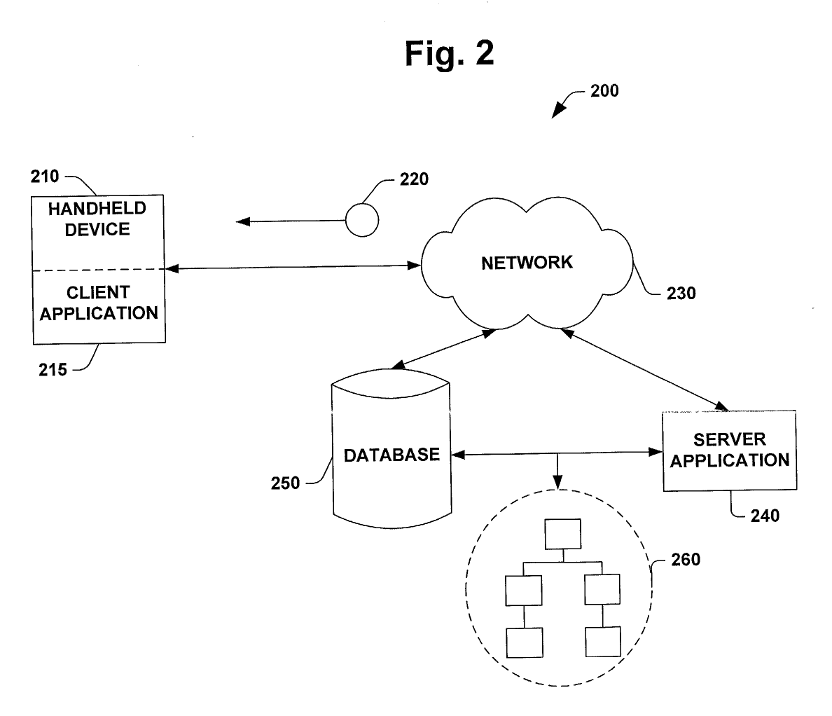

Turning now to FIG. 2, an example system 200 for managing prepartum medical records is illustrated. The system 200 includes a handheld device 210 on which a client application 215 runs. The handheld device 210 receives a customizable viewer via a computer communication 220 that transits a network 230. The customizable viewer can be transmitted to the handheld device 210 in a computer communication 220 as a BLOB. Additionally, and/or alternatively, the customizable viewer can be transmitted as a file (e.g., .PRC file). The customizable viewer can be customized based on attributes, including, but not limited to, a patient identifier, a viewer identifier, a viewer locale, and data requested by the handheld device 210. For example, a first physician may have a first viewer ID which would allow the first physician to access certain records and/or certain types of records. Therefore, the customizable viewer could be customized with selected computer executable components to facilitate the first physician viewing the selected records and the selected types of records. A second viewer, for example, a nurse, may have a second viewer ID which permits access to a different set of records and/or a different set of types of records. Thus, the customizable viewer may be customized in a second manner for the second viewer.

Similarly, the handheld device 210 and the customizable viewer may be customized based on the location of the handheld device 210. For example, the handheld device 210 may be located in a high signal-to-noise ratio environment (e.g., emergency room). Thus, sensing the location of the handheld device 210, the customizable viewer may be customized to display only data relevant to emergency situations. While two example customizations are described above, it is to be appreciated that the customizable viewer can be customized in other manners based on other customization parameters.

The system 200 includes a server application 240 that accesses a database 250 and an object hierarchy 260 to provide server support for the client side customizable viewer running on the handheld device 210. Thus, the server application 240 facilitates synchronizing medical records in the database 250 and on the handheld device 210. For example, the handheld device 210 and/or the customizable viewer may have received at a first point in time a first prepartum medical record. Since the time when the record was loaded on the handheld device 210, the record in the database 250 may have changed. For example, a laboratory result may have been reported to the database 250 but not to the handheld device 210. Thus, when a record access is made from the handheld device 210 through the customizable viewer to the database 250, the server application 240 facilitates synchronizing the two records to improve prepartum medical record management.

The server application 240 and the database 250 also facilitate time-stamping medical records stored in the database 250 which facilitates improving security. Furthermore, timestamping facilitates improving data integrity by preventing newer data being overwritten by older data. When older data tries to overwrite more current data, a client can be notified by, for example, an alert message and/or a log entry. Prepartum medical record security is enhanced by logging items, including, but not limited to, the time when a record is accessed, the identity of a party accessing a record, the time when a record is updated, and/or the time when a record is created.

The server application 240 and the database 250 interact with an object hierarchy 260 that facilitates customizing the viewer and building BLOBs to transmit across the network 230 to the handheld device 210. While the object hierarchy 260 is described primarily in the context of prepartum medical records, it is to be appreciated that the object hierarchy 260 can be adapted to other medical applications, including, but not limited to, cardiac intensive care, pediatrics, and so on. Thus, the customizable viewer running on the handheld device 210 can similarly be adapted to other medical applications.

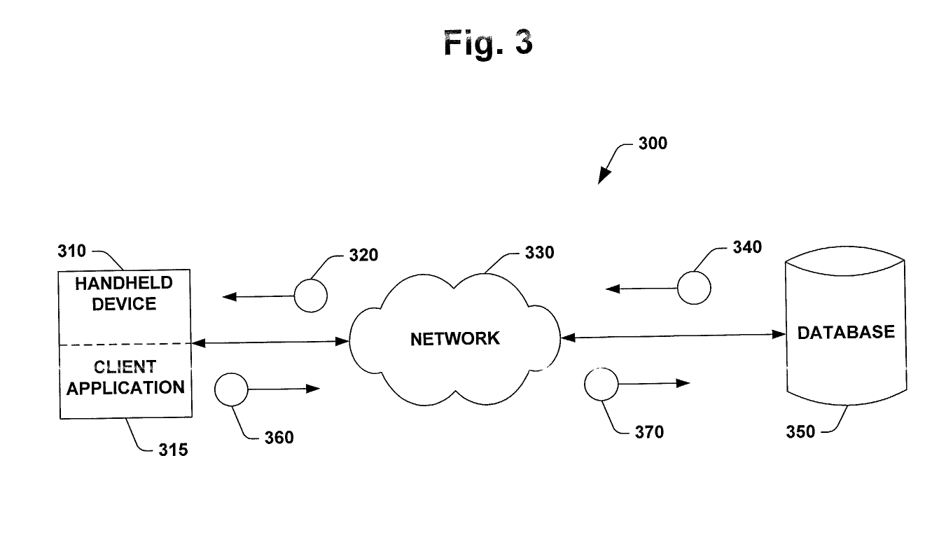

Referring now to FIG. 3, an example dataflow 300 between components of a system for managing prepartum medical records is illustrated. A handheld device 310 running a client application 315 may receive synchronizing data 320 across a network 330 that received synchronizing data 340 from a database 350. The handheld device 310 may transmit data 360 that it acquires during, for example, a patient examination, across the network 330. The data 360 is then transmitted as data 370 and/or a commit request to the database 350. If the database 350 and/or database management systems and/or server applications associated with the database 350 determine that the data on the handheld device 310 is not synchronized with the data in the database 350, then the synchronization data 340 may be transmitted across the network 330 and received as the synchronized data 320 at the handheld device 310. Thus, the handheld device 310, a client application 315, and/or a customizable viewer running on the handheld device 310 can, in one example, access a database that is updated substantially in real time providing advantages over conventional systems where handheld devices synchronize their data less frequently (e.g., once a day), allowing such data to rapidly become out of date.

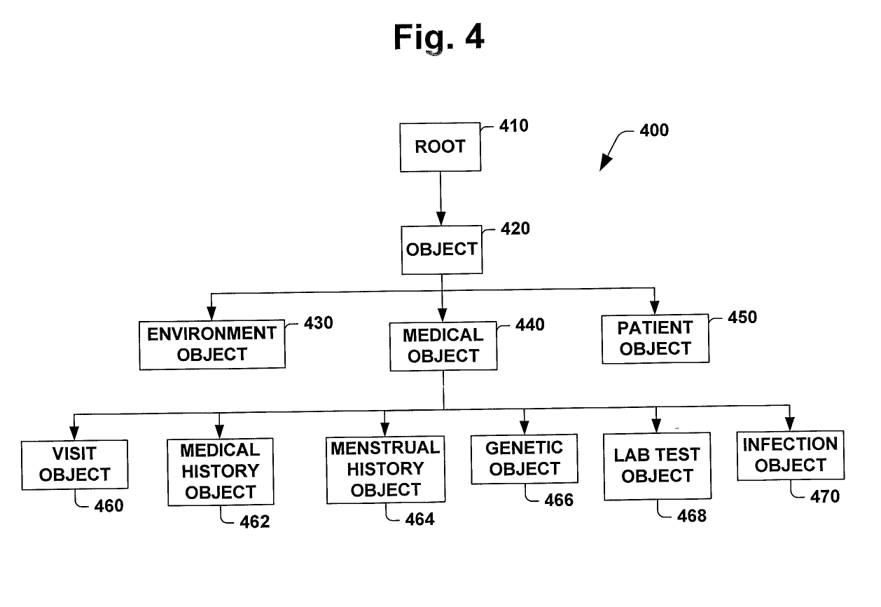

FIG. 4 illustrates an example object hierarchy 400 associated with managing prepartum medical records. A root object 410 is located at the top of the hierarchy 400. The object hierarchy 400 includes objects modeling office visits, menstrual history, medical history, past pregnancies and so on. For example, the hierarchy 400 includes a medical object class 440 derived from an object class 420. A variety of classes (e.g., visit 460, genetics 466, infection 470) derive from the medical object class 440. It is to be appreciated that hierarchy 400 is but one example hierarchy and that other hierarchies with a greater and/or lesser number of classes and different dependencies can be employed with the systems, methods, and so on described herein.

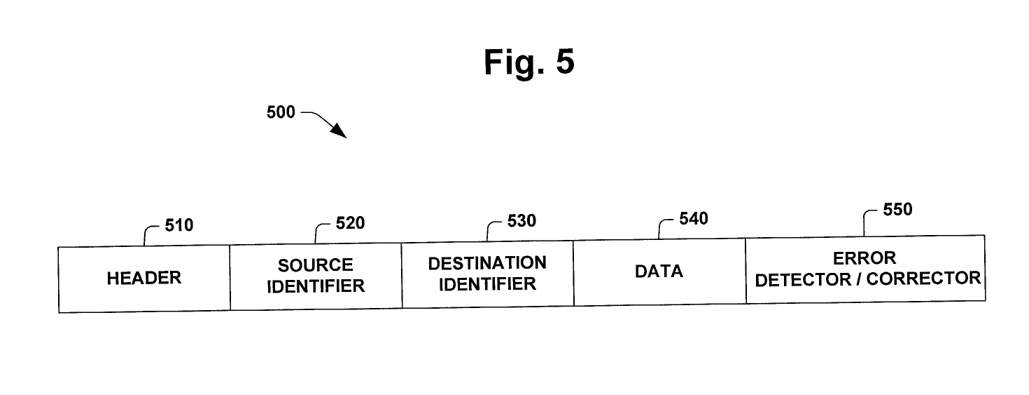

Referring now to FIG. 5, information can be transmitted between various computer components associated with managing prepartum medical records described herein via a data packet 500. An exemplary data packet 500 is shown. The data packet 500 includes a header field 510 that includes information like the packet length and type. A source identifier 520 follows the header field 510 and includes, for example, an address of the computer component from which the packet 500 originated. Following the source identifier 520, the packet 500 includes a destination identifier 530 that holds, for example, an address of the computer component to which the packet 500 is ultimately destined. Source and destination identifiers can be, for example, globally unique identifiers, URLS (uniform resource locator), path names, and the like. The data field 540 in the packet 500 includes various information intended for the receiving computer component. The data packet 500 ends with an error detecting and/or correcting field 550 whereby a computer component can determine if it has properly received the packet 500. While six fields are illustrated in the data packet 500, it is to be appreciated that a greater and/or lesser number of fields can be present in data packets.

In one example data packet, a complete executable binary file is transmitted to facilitate automatically receiving, installing, and executing a data aware record manager. Thus, along with updated data, a user receives, via the data packet, an updated GUI that understands how to interact with the updated data. In another example data packet, one or more components of the electronically dynamically configurable client side prepartum medical record viewer are transmitted as a binary large object (BLOB). A BLOB is an aggregation of related binary data that is stored as a single entity in a data store (e.g., database). A BLOB can be used to store, for example, programs, program fragments, code fragments, and other items like images, videos, sound and so on. Thus, the data field 540 may hold, for example, one or more BLOBs and/or portions thereof that store computer executable portions of an electronically dynamically configurable client side prepartum medical record viewer and/or manager.

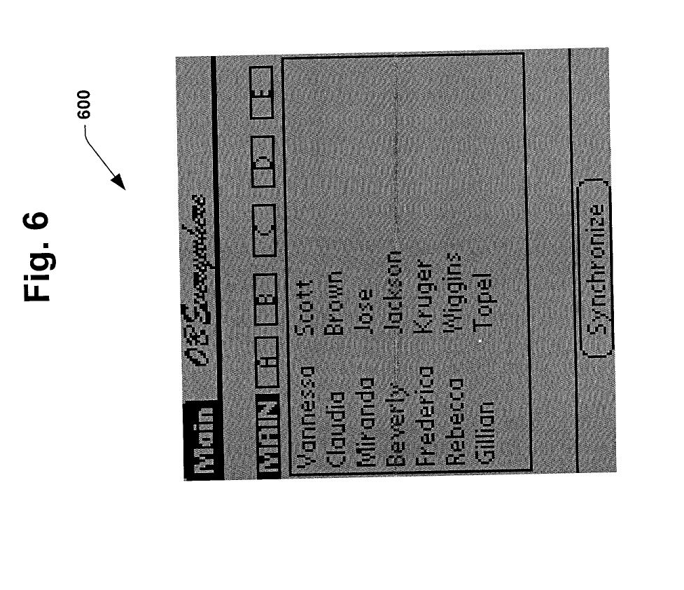

FIG. 6 is a simulated screen shot 600 from an electronically dynamically configurable prepartum medical record viewer. This simulated screen shot 600 represents a main menu wherein a list of patient names is displayed. At the bottom of the simulated screen shot 600 is a synchronize button that facilitates the user of the handheld device, upon which the medical record viewer runs, to request synchronization of prepartum medical records stored on the handheld device and a remote database. The simulated screen shot 600 may be displayed by, for example, a “generic” or “initial” viewer loaded into the handheld device. Subsequently, the customizable viewer may be customized by adding one or more computer executable components to display data associated with a particular patient, condition, history, and so on. The viewer may be customized based on attributes including, but not limited to, a viewer identifier (e.g., physician ID, nurse ID, laboratory ID), a patient identifier, a locale identifier (e.g., hospital, office, insurance company), and so on. The data displayed on the example screen shot 600 may be retrieved from a remote database by a query (e.g., structured query language (SQL)), made against the database substantially in real time. Based, for example, on the list of patients retrieved, various computer executable components of the displayable viewer may be transmitted as one or more BLOBs to the handheld device to facilitate viewing prepartum medical records associated with the patients retrieved in response to the initial query.

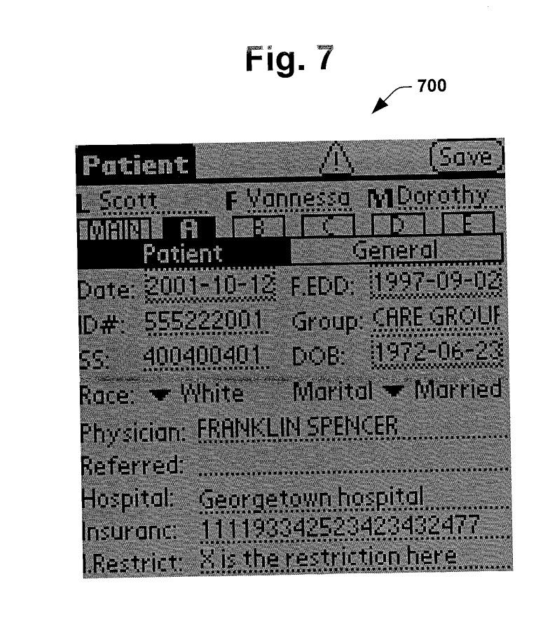

FIG. 7 is a simulated screen shot 700 from an electronically dynamically configurable prepartum medical record viewer. The screen shot 700 displays general patient information like the patient name, the current date, a patient identifier, a social security number, a physician, a hospital, and so on. Conventionally, such screens were preprogrammed by the developer of the application and were difficult to customize, if such customizations were possible at all. The present application concerns a viewer where, not only are the screens customizable, but they are dynamically electronically configurable. The screens can be customized based on data modeled in an object hierarchy and managed by an object oriented server application with which the handheld device displaying the viewer communicates. The screen shot 700 illustrates fields like a marital field beside which a value “married” is displayed. Conventionally, a person entering data into a medical record would write or dictate a field value for the marital field. While there is only a finite logical set of values (e.g., single, married, divorced, separated), previously, there was nothing preventing the person entering the data from entering an invalid value and/or an illegible value. Thus, the configurable viewer employs forms-based input to facilitate mitigating problems with entering incorrect values and transcribing illegible data. Furthermore, by using forms-based input, the configurable viewer mitigates problems with skipping required fields by requiring, for example, a person entering data to complete a subset of required fields before moving on. Furthermore, based on information stored in the prepartum medical record as updated by a user interfacing with the example screen shot 700, the server application may suggest dates for tests and/or types of tests, as will be discussed in greater detail later.

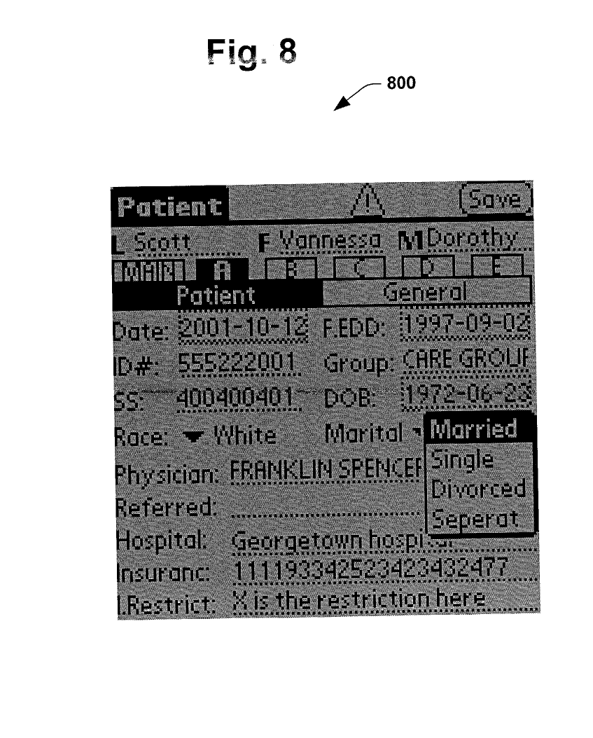

Turning to FIG. 8, an example dropdown list associated with forms-based input is illustrated on an example screen shot 800. The marital field is associated with a dropdown list that provides a menu of logical entries for this field. Thus, problems associated with illegible writing and/or inappropriate data entries are mitigated through the configurable prepartum medical record viewer. While a set of entries for the marital field is illustrated, it is to be appreciated that other menus for other forms-based input fields are available for the configurable viewer. For example, a blood type menu that includes entries A, AB, B, and O facilitates receiving valid data values and legible data values. While two menus are described, it is to be appreciated that a greater and/or lesser number of menus may be associated with the customizable viewer.

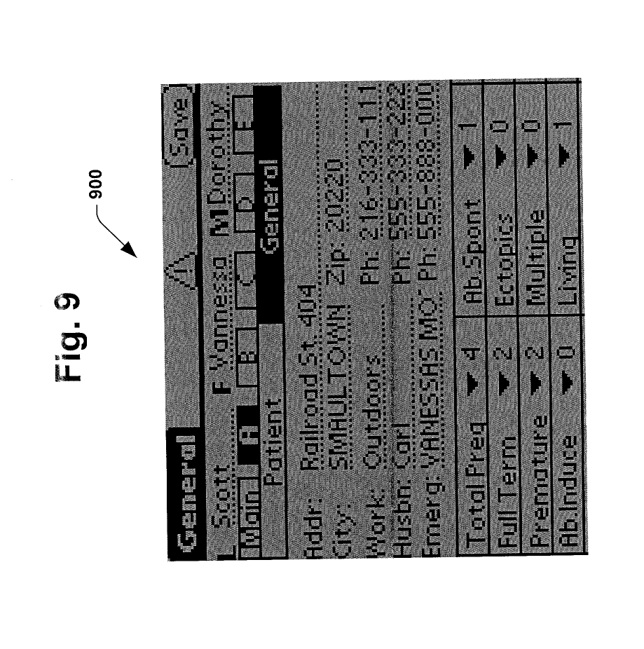

FIG. 9 illustrates a simulated screen shot 900 from the prepartum medical record viewer. This screen shot 900 illustrates patient pregnancy information including, for example, the number of total pregnancies, how many went full term, how many resulted in a premature birth, and so on. The simulated screen shot 900 includes a field “full term” that is only relevant if the total number of pregnancies is greater than zero. Therefore, based on the patient record, if the total number of pregnancies were zero, then the terms like full term, number of premature births, and so on, would be irrelevant. Thus, the customizable viewer may not display such fields. Since the fields are not displayed, computer executable components required to display such fields may not be transmitted to the handheld device running the customizable viewer, facilitating minimizing data transfers and memory requirements for the handheld device. Similarly, values for certain fields, like zip code, may lead to the customizable viewer being selectively updated by transmitting other computer executable components of the customizable viewer. For example, if the zip code indicated that the patient resided in a cancer cluster zip code, then a subsequent screen associated with gathering and/or displaying information relevant to cancer cluster zip codes may be downloaded to the handheld device and the navigation of the customizable viewer may be adapter so that the cancer cluster information will be gathered. While zip code and number of pregnancy examples are described and associated with screen shot 900, it is to be appreciated that other selectively downloadable computer executable components may be transmitted to a handheld device running the customizable viewer to improve the prepartum medical record application.

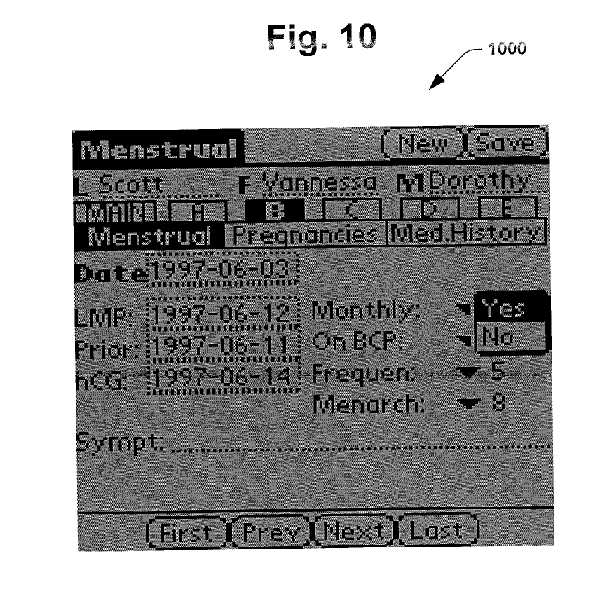

FIG. 10 also illustrates a simulated screen shot 1000 from a prepartum medical record viewer The simulated screen shot 1000 facilitates gathering and/or displaying patient menstrual history data. In addition for forms-based input that facilitates inputting dates, for example, a field labeled “sympt:” allows free form input of data. Thus, the person inputting the data is not constrained solely to the information contained on the forms. While menstrual history data is illustrated in FIG. 10, it is to be appreciated that the customizable viewer can process data including, but not limited to, a patient pregnancy data, a patient medication data, a patient identification data, a patient menstrual data, a patient genetic data, a patient exam data, a patient illness data, and a patient medical history data.

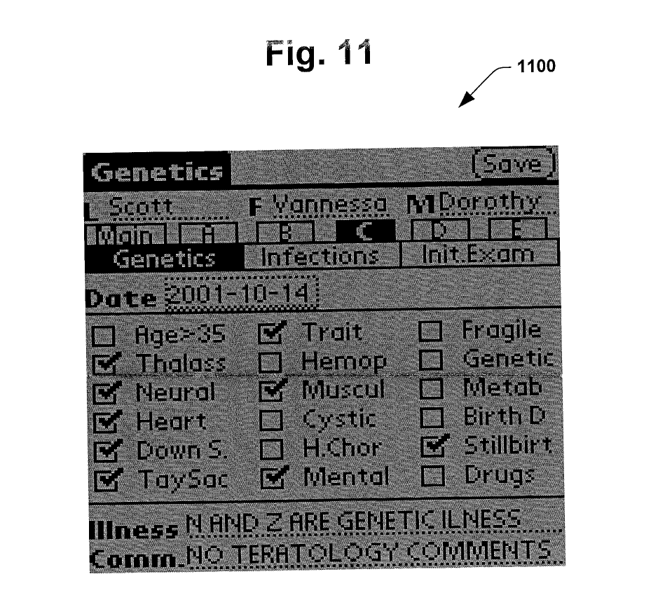

FIG. 11 illustrates a simulated screen shot 1100 from a prepartum medical record viewer The screen shot 1100 illustrates three possible screens on a menu, a genetics screen, an infections screen, and an initial exam screen. In screen shot 1100, the genetics screen has been selected, and a number of check boxes are illustrated. The person entering the data may check a box to indicate certain genetic traits. Based on the input, the customizable viewer and/or he server application facilitates selectively filtering what is relevant to the patient and/or the doctor at various times.

During the gestation period, there are different laboratory experiments that can be performed. To facilitate providing optimal healthcare and/or to facilitate avoiding liability for not ordering suggested tests, the customizable viewer and/or the server application facilitates suggesting certain tests at certain times. These suggestions may be made, at least in part, on genetic information input through the sample screen shot 1100. Furthermore, checking a box (e.g., Down's Syndrome) can lead to the customizable viewer being customized with other screens designed to facilitate following up on the checked box. Based on the follow-up, the customizable viewer, the client side application, and/or the server side application may prompt a doctor to order certain sets of tests based on initial genetic screening and/or lab results received from tests ordered in response to the initial genetic screening.

Similarly, data gathered through an infections screen may lead to further customization of the viewer and/or further suggested tests. Infections may be related to immunities (e.g., Rubella) and thus be important to pregnancy. For a field like Rubella, there are two choices, either the woman is immune or she is not. By using forms-based input, only one of those two valid choices can be entered, and it will be entered in a legible manner. This facilitates mitigating problems with incorrect data and/or illegible data. If a field like Rubella is completed in a manner that requires the doctor to be notified of follow-up questions and/or follow up tests, then the customizable viewer can be customized when the record for that patient is retrieved. This facilitates minimizing memory requirements for the handheld device upon which the customizable viewer will be displayed and further facilitates improving the quality of healthcare delivered to the patient.

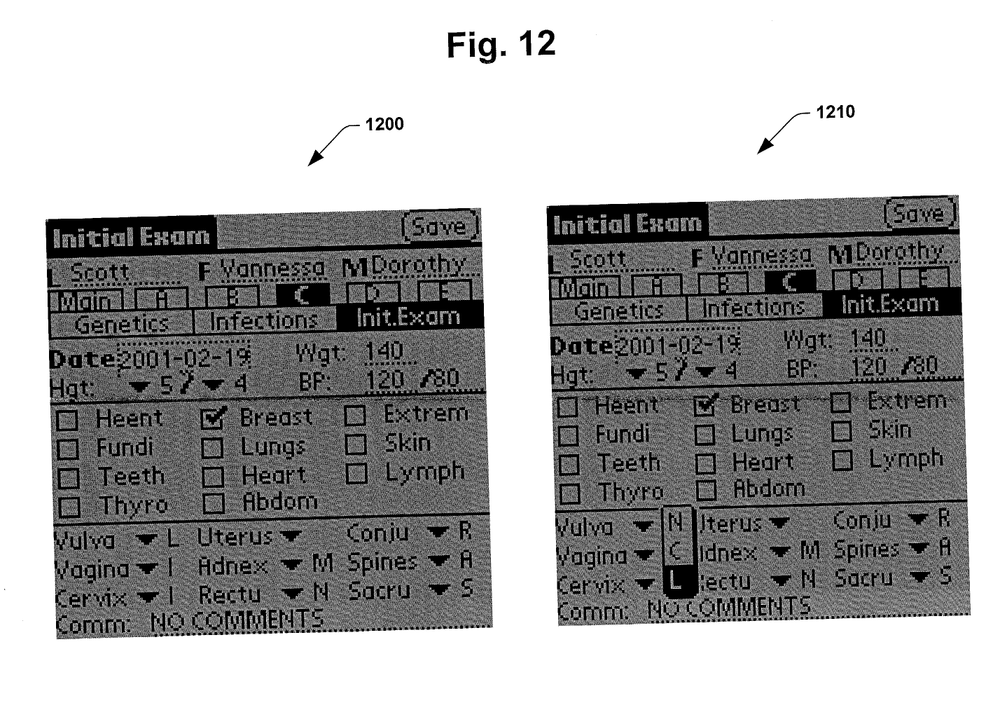

FIG. 12 illustrates two sample screen shots from a prepartum medical record viewer.

Screen shot 1200, on the left of FIG. 12, illustrates an initial exam screen that is partially completed. Again illustrating the value of forms-based input, for a field like “vulva,” three possible values (e.g., N, C, L) are available. Since only three values are valid, a dropdown menu is illustrated in sample screen shot 1210. This dropdown menu facilitates entering a valid, legible value. Based on the value, the customizable viewer may be customized with subsequent screens designed to elicit and store information based on the data input to the menu.

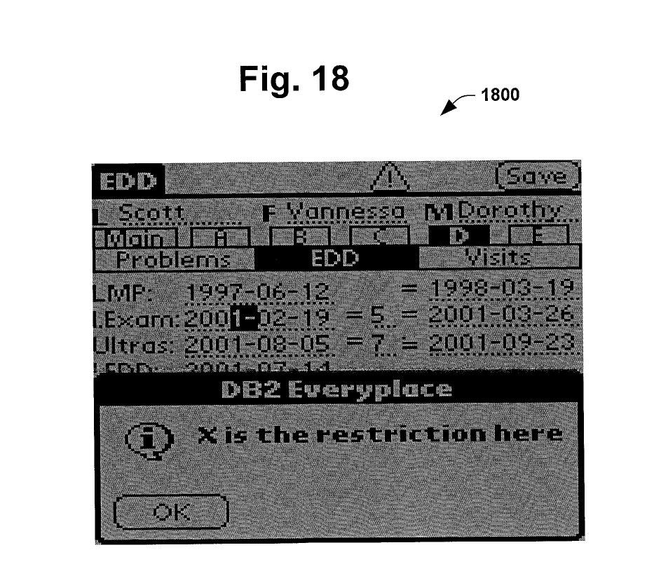

The customizable viewer also facilitates preventing the inadvertent disclosure of medical data. For example, a pregnant woman may not want certain medical data disclosed to other family members. By way of illustration, a woman may not want family members to be aware of the total number of pregnancies the woman has experienced. Furthermore, patients may not wish certain information (e.g., the gender of the unborn baby) to be disclosed. While such information may be available to the physician through the customizable viewer, a reminder can be displayed on the customizable viewer to remind the physician not to disclose this information. Additionally, and/or alternatively, the customizable viewer may initially lock out such data in connection with the printed reminder to further facilitate the inadvertent disclosure of data. An example restricted information screen is illustrated in FIG. 18.

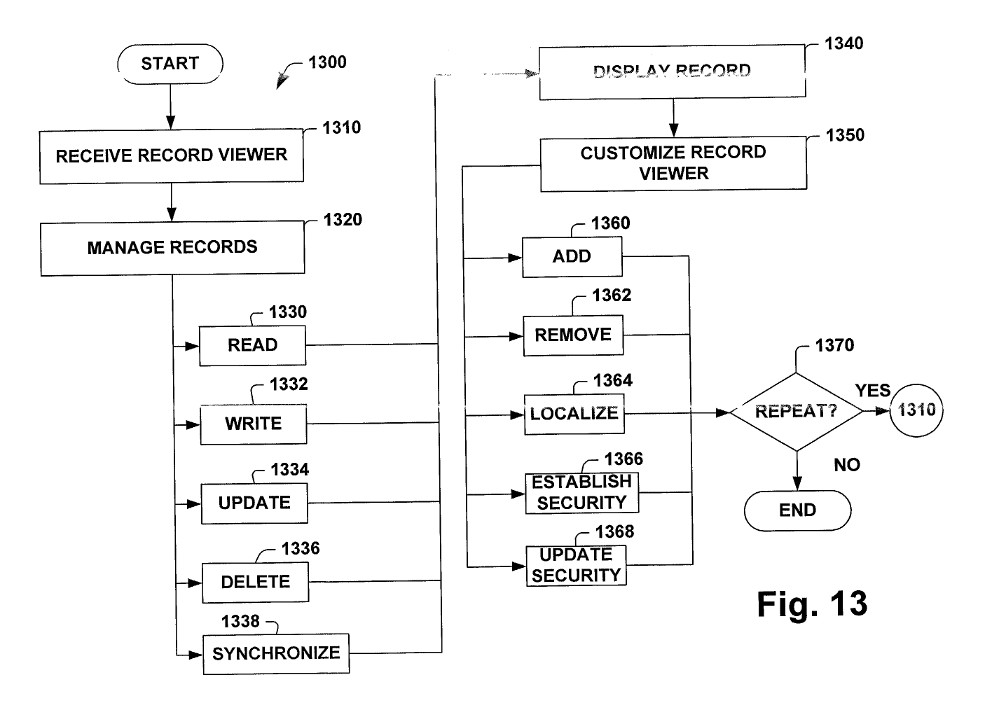

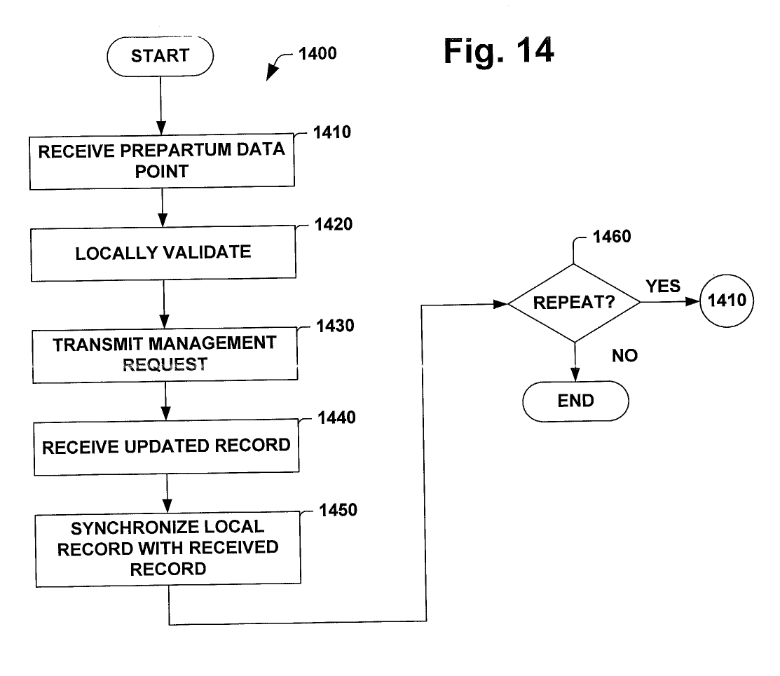

In view of the exemplary systems shown and described herein, example methodologies that are implemented will be better appreciated with reference to the flow diagrams of FIGS. 13 and 14. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional, not illustrated blocks. In one example, methodologies are implemented as computer executable instructions and/or operations stored on computer readable media including, but not limited to an application specific integrated circuit (ASIC), a compact disc (CD), a digital versatile disk (DVD), a random access memory (RAM), a read only memory (ROM), a programmable read only memory (PROM), an electronically erasable programmnable read only memory (EEPROM), a disk, a carrier wave, and a memory stick.

In the flow diagrams, rectangular blocks denote “processing blocks” that may be implemented, for example, in software. Similarly, the diamond shaped blocks denote “decision blocks” or “flow control blocks” that may also be implemented, for example, in software. Alternatively, and/or additionally, the processing and decision blocks can be implemented in functionally equivalent circuits like a digital signal processor (DSP), an application specific integrated circuit (ASIC), and the like.

A flow diagram does not depict syntax for any particular programming language, methodology, or style (e.g., procedural, object-oriented). Rather, a flow diagram illustrates functional information one skilled in the art may employ to program software, design circuits, and so on. It is to be appreciated that in some examples, program elements like temporary variables, routine loops, and so on are not shown.

FIG. 13 is a flow chart of an example method 1300 for managing prepartum medical records At 1310, a record viewer is received. The record viewer may be received electronically via a computer communication into a handheld computing device, for example. The record viewer may be, for example, an electronically dynamically customizable prepartum medical record viewer. At 1320, the method 1300 includes managing one or more prepartum medical records through the record viewer received at 1310. Managing a prepartum medical record can include, but is not limited to, reading, writing, updating, deleting, and synchronizing prepartum medical records. Furthermore, at 1320, security management and file encryption can occur.

A 1330, a prepartum medical record may be selectively read. Similarly, at 1332, a prepartum medical record may be selectively written and at 1334, a prepartum medical record may be selectively updated. At 1336, a prepartum medical record may be selectively deleted and at 1338 a prepartum medical record may be selectively synchronized with a remote medica record stored, for example, on a remote database.

At 1340, a prepartum medical record is displayed. While block 1340 appears after block 1320, it is to be appreciated that the blocks in FIG. 13 may be arranged in different orders and that, therefore, the record may be displayed before it is managed at 1320 and 1330-1338.

At 1350, the records viewer can be customized. For example, one or more computer executable components of a record viewer may be transmitted to a handheld device on which the record viewer was previously received. These computer executable components may be transmitted in a computer communication as a BLOB. The customizable record viewer may be customized in ways including, but not limited to, adding components, removing components, localizing the viewer, and establishing and/or updating a security level for the viewer Thus, at 1360, a computer executable component is added to the record viewer initially received at 1310. Similarly, at 1362, a component is removed from the record viewer and at 1364, one or more computer executable components in the record viewer are localized. By way of illustration of localization, a physician identifier may indicate that a physician prefers to communicate in English and thus the record viewer will have its menus displayed in English, while a second physician identifier may indicate that the physician prefers to communicate in Spanish and thus the menus will be displayed in Spanish. Similarly, a first patient identifier may indicate that, although the patient is interacting with an English-speaking physician, the patient would prefer to receive certain information in Spanish, and thus certain information to be communicated to the patient by the physician may appear in both English and Spanish.

At 1366, a security level may be established for the record viewer. The security level may be established based on factors including, but not limited to, a physician identifier, a patient identifier, a nurse identifier, a hospital identifier, and so on. Based on the security level, the customizable viewer may be configured to display more or less information and/or more or less types of information. By way of illustration, a high security level may permit a viewer to view substantially all records and substantially all types of records, while a second lower security level may only permit viewing of a subset of records and/or a subset of types of records. Thus, the customizable viewer facilitates compliance with standards like the Health Insurance Portability and Accountability Act (HIPAA). At 1368, the security level may be updated. In one example, information sent to a user is pre-filtered on a server to facilitate optimizing throughput and to mitigate storing unusable data on a PDA. Furthermore, the prefiltering facilitates preventing a user from inadvertently being presented with data not intended for a given medical practice.

At 1370, a determination is made concerning whether to repeat one or more steps of the method 1300. If the determination is yes, then the process returns to 1310, otherwise the methods 1300 can conclude.

Turning now to FIG. 14, an example method 1400 for managing prepartum medical records is illustrated. At 1410, a prepartum data point is received. A prepartum data point can be, for example, a field in a prepartum medical record. Thus, example prepartum data points include, but are not limited to, a patient name, a patient blood pressure, a patient unborn baby gender, and so on. Since prepartum data points may have a finite set of valid values, at 1420, the prepartum data point can be locally validated.

At 1430, a prepartum medical record management request is generated and transmitted to, for example, a server application and/or a database with which the handheld computing device on which the method 1400 is running is in communication. The prepartum medical record management request may carry one or more locally validated prepartum data points and/or other prepartum data points as well.

At 1440, after processing performed at the server application and/or the remote database, the method 1400 receives an updated record. Additionally, and/or alternatively, the method will receive an error message indicating that the prepartum medical record management request was invalid and/or not completed. The management request transmitted at 1430 and/or the record received at 1440 may be transmitted, for example, wholly and/or in part, in an extensible mark-up language (XML) file via one or more hypertext transfer protocol (HTTP) messages.

At 1450, a local medical record may be synchronized with a record received at 1440. For example, the prepartum data point received at 1410, validated at 1420, and transmitted with the management request at 1430 may have lead to the server application updating a record in a remote database. Thus, the updated record was transmitted and then received at 1440, and was out of synchronization with the record and/or data on the handheld device. Therefore, at 1450, the record on the handheld device and the record in the remote database are synchronized. This real time synchronization of data facilitates improving patient care and provides advantages over conventional system, where this type of synchronization occurs, for example, once a day. At 1460, a determination is made concerning whether to repeat one or more of the steps of method 1400. If the determination at 1460 is yes, then processing returns to step 1410, otherwise processing concludes.

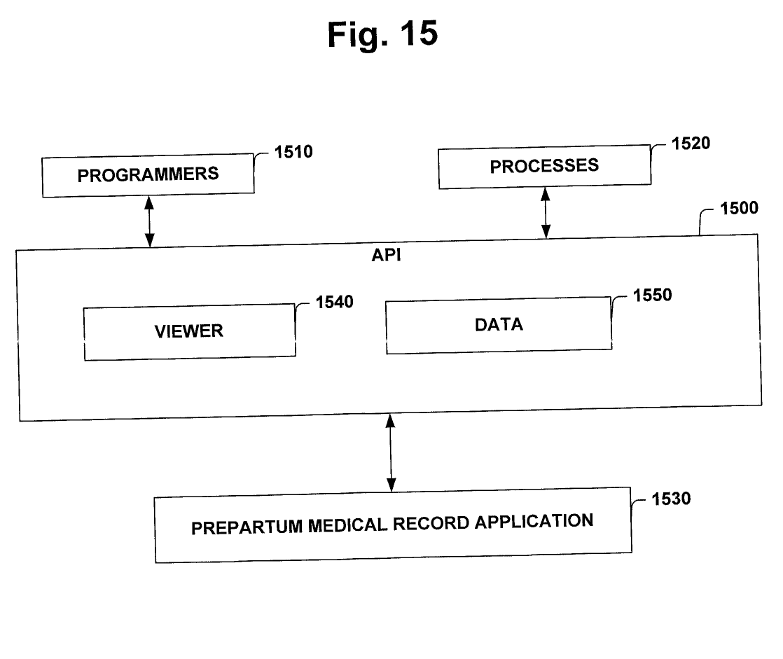

Referring now to FIG. 15, an application programming interface (API) 1500 is illustrated providing access to an application 1530 for managing prepartum medical records. The API 1500 can be employed, for example, by programmers 1510 and/or processes 1520 to gain access to processing performed by the application 1530. For example, a programmer 1510 can write a program to access the prepartum medical record application 1530 (e.g., to invoke its operation, to monitor its operation, to access its functionality) where writing the program is facilitated by the presence of the API 1500. Thus, rather than the programmer 1510 having to understand the internals of the application 1530, the programmer's task is simplified by merely having to learn the interface to the application 1530. This facilitates encapsulating the functionality of the application 1530 while exposing that functionality. Similarly, the API 1500 can be employed to provide data values to the application 1530 and/or retrieve data values from the application 1530. For example, a process 1520 that receives an electronically configurable prepartum medical record viewer can interact with the application 1530 via the API 1500. Thus, in one example of the API 1500, a set of application program interfaces can be stored on a computer-readable medium. The interfaces can be executed by a computer component to gain access to a prepartum medical record application. Interfaces can include, but are not limited to, a first interface that receives and/or transmits components of an electronically configurable prepartum medical record viewer and a second interface that receives and/or transmits prepartum medical record data points.

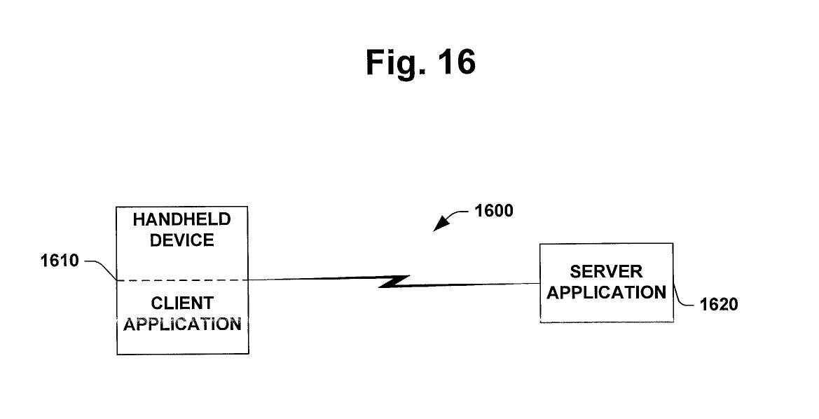

FIG. 16 illustrates an example signal 1600 passing between a client application 1610 running on a handheld device and a server application 1620 where the client application 1610 and the server application 1620 are components of a prepartum medical record managing system, The signal 1600 can transmit code segments from the server application 1620 to the client application 1610. Thus, the computer data signal 1600 embodied in a transmission medium may include a code segment that has instructions for displaying a prepartum medical record. In this manner, a customizable prepartum medical record viewer can be transmitted from the server application 1620 to the client application 1610 and/or handheld device. Furthermore, the computer data signal 1600 can include a code segment that has instructions for generating a request to synchronize a prepartum medical record between the client application 1610 and the server application 1620.

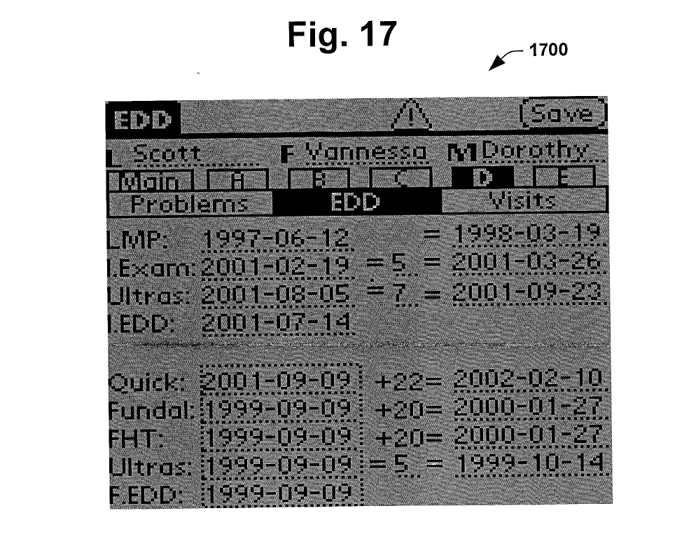

Turning now to FIG. 17, a screen shot 1700 of an example of how an electronically dynamically configurable prepartum medical record viewer can facilitate relating data is illustrated. The last menstrual period date is one way to calculate an expected delivery date (EDD) This date, along with other dates in the gestation cycle are employed to calculate estimates for the expected delivery date. The EDD information can be summarized on a screen 1700 that presents related dates together. If a user wants to make a change in the date of the last menstrual period from the expected delivery date form, clicking on the last menstrual period data on the EDD form can take the user, for example, to a form that summarizes the menstrual history data. This facilitates associating related data. When the user makes a change or decides to cancel a change, the use can then be returned to the EDD form from which the navigation began.

The systems, methods, and objects described herein may be stored, for example, on a computer readable media. The media can include, but are not limited to, an application specific integrated circuit (ASIC), a compact disc (CD), a digital versatile disk (DVD), a random access memory (RAM), a read only memory (ROM), a programmable read only memory (PROM), a disk, a carrier wave, a memory stick, and the like.

Thus, an example computer readable medium can store computer executable instructions for managing prepartum medical records that includes electronically receiving, into a handheld computing device, via a computer communication, an electronically customizable prepartum medical record viewer, and managing one or more prepartum medical records through the electronically customizable prepartum medical record viewer.

Similarly, an example computer readable medium can store computer executable components of a system for managing prepartum medical records that includes an object hierarchy that models a prepartum medical record and/or a component of a client/server application for managing prepartum medical records, a data store that stores components of a dynamically configurable client side prepartum medical record manager, a client application that receives and assembles components of the dynamically configurable client side prepartum medical record manager, a server application, written in an object oriented programming language (e.g. Smalltalk), for selecting and transmitting a component of the dynamically configurable client side prepartum medical record manager, and a data store that stores prepartum medical records that are selectively managed by the server application, the client application, and/or the dynamically configurable client side prepartum medical record manager.

What has been described above includes several examples. It is, of course, not possible to describe every conceivable combination of components or methodologies for purposes of describing the methods, systems, APIs, GUIs, signals, computer readable media and so on employed in managing prepartum medical records. However, one of ordinary skill in the art may recognize that further combinations and permutations are possible. Accordingly, this application is intended to embrace alterations, modifications, and variations that fall within the scope of the appended claims. Furthermore, to the extent that the term “includes” is employed in the detailed description or the claims, it is intended to be inclusive in a manner similar to the term “comprising” as that term is interpreted when employed as a transitional word in a claim.

What is claimed is:

1. A computer implemented method for managing prepartum medical records, comprising:
electronically receiving, into a handheld computing device, via a computer communication, an electronically dynamically customizable prepartum medical record viewer; and
managing one or more prepartum medical records through the electronically dynamically customizable prepartum medical record viewer.

2. The method of claim 1, where managing a prepartum medical record comprises at least one of, reading a prepartum medical record, writing a prepartum medical record, updating a prepartum medical record, deleting a prepartum medical record, and synchronizing a local prepartum medical record with a remote prepartum medical record.

3. The method of claim 1, comprising selectively displaying one or more fields of a prepartum medical record through the electronically dynamically customizable prepartum records viewer.

4. The method of claim 1, where the electronically dynamically customizable prepartum medical record viewer is received as one or more binary large objects (BLOBs).

5. The method of claim 4, comprising, customizing the electronically dynamically customizable prepartum medical record viewer by at least one of, electronically adding a prepartum medical record viewing component received as a BLOB in a computer communication, electronically removing a prepartum medical record viewing component, electronically localizing a prepartum medical record viewing component, electronically establishing a security level for a record managing session, and electronically updating a security level for a record managing session.

6. The method of claim 1, where the electronically dynamically customizable prepartum medical record viewer is received as a .PRC file.

7. The method of claim 1, comprising:
receiving one or more prepartum medical record data points;
locally validating the one or more prepartum medical record data points;
transmitting, by a computer communication, a prepartum medical record management request that carries one or more validated prepartum medical record data points; and
receiving one of, a prepartum medical record updated according to the prepartum record management request and an error code.

8. The method of claim 7, comprising, in real time, synchronizing a local prepartum medical record with the received prepartum medical record.

9. The method of claim 7, where validating a prepartum medical record data point comprises at least one of, range checking, relationship checking, and error checking.

10. A computer readable medium storing computer executable instructions operable to perform the method of claim 1.

11. A system for managing prepartum medical records, comprising:
an object hierarchy that models at least one of, a prepartum medical record and a component of a client/server application for managing prepartum medical records;
a client application for receiving and assembling one or more components of an electronically dynamically configurable client side prepartum medical record manager; and
a server application, written in an object oriented programming language, for selecting and transmitting a component of the electronically dynamically configurable client side prepartum medical record manager.

12. The system of claim 11, where the client application receives the components of the electronically dynamically configurable client side prepartum medical record manager in a computer communication as one of an executable file and a BLOB.

13. The system of claim 11, where the server application is written in the Smalltalk programming language.

14. The system of claim 11, comprising a first data store that stores one or more components of the electronically dynamically configurable client side prepartum medical record manager.

15. The system of claim 14, where the first data store is a first relational database.

16. The system of claim 15, where the first relational database is one of a DB2 database, an Oracle database, and an SQL database.

17. The system of claim 14, comprising a second data store that stores one or more prepartum medical records that are selectively managed by at least one of the server application, the client application, and the electronically dynamically configurable client side prepartum medical record manager.

18. The system of claim 17, where the second data store is a second relational database.

19. The system of claim 18, where the second relational database is one of a DB2 database, an Oracle database, and an SQL database.

20. The system of claim 11, comprising a handheld computing device for running the client application and the dynamically configurable prepartum medical record manager.

21. The system of claim 20, where the handheld computing device is one of a Palm Pilot, a computer running Windows CE, a pocket PC, a laptop computer, and a cellular telephone.

22. A computer readable medium storing computer executable components of the system of claim 11.

23. A computer readable medium storing an object hierarchy, comprising:
a root object from which one or more dependent objects depend, where the root object models one or more aspects of a prepartum medical record; and
one or more dependent objects that depend from the root object, where the dependent objects model one or more aspects of a prepartum medical record.

24. The computer readable medium of claim 23, where the one or more aspects comprise at least one of, a patient pregnancy data, a patient medication data, a patient identification data, a patient menstrual data, a patient genetic data, a patient exam data, a patient illness data, and a patient medical history data.

25. In a handheld, client side, prepartum medical record managing computer system having a graphical user interface including a display and a selection device, a method of providing and selecting from a menu on the display, the method comprising:
retrieving a set of menu entries for the menu, each of the menu entries representing an aspect of a prepartum medical record;
displaying the set of menu entries on the display;
receiving a menu entry selection signal indicative of the selection device pointing at a selected menu entry from the set of menu entries; and
in response to the signal, generating a prepartum medical record management request for transmission to a server side prepartum medical record management application.

26. A set of application programming interfaces embodied on a computer readable medium for execution on a hand-held computing device in conjunction with a client side prepartum medical record managing application program, comprising:
a first interface that receives one or more components of an electronically dynamically configurable prepartum medical record viewer; and
a second interface that receives a prepartum medical record data point for display by the one or more components of the electronically dynamically configurable prepartum medical record viewer received by the first interface.

27. The computer readable medium of claim 26, where the one or more components of the electronically dynamically configurable prepartum medical record viewer are received as one of one or more BLOBs and an executable file via one or more computer communications.

28. The computer readable medium of claim 26, where the prepartum medical record data point is received in an extensible markup language (XML) file via one or more hypertext transfer protocol (HTTP) messages.

29. A computer data signal embodied in a transmission medium, comprising:
a code segment including instructions for displaying a prepartum medical record; and
a code segment including instructions for generating a request to synchronize a displayed prepartum medical record with a stored prepartum medical record.

30. A system for managing medical records, comprising:
an object hierarchy that models a medical record;
a client device for receiving a dynamically configured executable medical record manager for managing medical records modeled in the object hierarchy; and
a server application for dynamically configuring an executable medical record manager.

31. The system of claim 30, where the client device receives the dynamically configured executable medical record manager as one of a .PRC file and a BLOB.

32. The system of claim 30, where the server application is written in an object-oriented programming language.

33. The system of claim 32, where the object-oriented programming language is one of Smalltalk, Java, C#, and C++.

34. The system of claim 30, where the dynamically configured executable medical record manager is written in an object-oriented programming language.

35. The system of claim 34, where the object-oriented programming language is one of Smalltalk, Java, C#, and C++.

36. The system of claim 30, where the medical records concern one or more of prepartum medical data, cardiac medical data, pediatric medical data, and nephrology medical data.
